(19) United States
(12) Patent Application Publication
(10) Pub. No.: US 2021/0357751 A1
(43) Pub. Date: Nov. 18, 2021

(54) EVENT-BASED PROCESSING USING THE OUTPUT OF A DEEP NEURAL NETWORK

(71) Applicant: Hewlett-Packard Development Company, L.P., Spring, TX (US)

(72) Inventors: Madhu Sudan Athreya, Palo Alto, CA (US); M. Anthony Lewis, Palo Alto, CA (US)

(73) Assignee: Hewlett-Packard Development Company, L.P., Spring, TX (US)

(21) Appl. No.: 17/280,932

(22) PCT Filed: Nov. 28, 2018
(86) PCT No.: PCT/US2018/062876

§ 371 Date: Mar. 29, 2021

(51) Int. Cl. G06N 3/08; G06N 3/04

(52) U.S. Cl. CPC G06N 3/08; G06N 3/049; G06N 3/0454

(57) ABSTRACT

Examples for event-based processing using the output of a deep neural network are described herein. In some examples, event format data may be provided to a spiking neural network (SNN). The SNN may perform processing on the event format data. The SNN may be trained for processing the event format data based on an output of a deep neural network (DNN) trained for processing of sensing data.

### BACKGROUND

Computing devices are used to perform a variety of tasks, including work activities, banking, research, and entertainment. In some examples, computing devices may be used to capture and process sensing data. For instance, a camera may capture image data. In another example, a microphone may capture audio signals. Signal processing may then be performed on the sensing data.

### BRIEF DESCRIPTION OF THE DRAWINGS

Various examples will be described below by referring to the following figures.

FIG. 1 is an example block diagram of a computing device in which event-based processing using the output of a deep neural network (DNN) may be performed;

FIG. 2 is an example flow diagram illustrating a method for event-based processing using the output of a DNN;

FIG. 3 is an example flow diagram illustrating another method for event-based processing using the output of a DNN;

FIG. 4 is an example flow diagram illustrating another method for event-based processing using the output of a DNN;

FIG. 5 is another example block diagram of a computing device in which event-based processing using the output of a DNN may be performed;

FIG. 6 is an example block diagram illustrating time synchronization for the event-based processing described herein;

FIG. 7 is an example block diagram illustrating spatial-temporal correspondence for the event-based processing described herein;

FIG. 8 is an example illustrating an implementation of spatial-temporal correspondence for event-based processing;

FIG. 9 is an example illustrating another implementation of spatial-temporal correspondence for event-based processing; and

FIG. 10 is an example of labeled data generation for event-based processing.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Examples of spiking neural network (SNN) signal processing based on the output of a deep neural network (DNN) are described herein. In some examples, the SNN may be trained based on input from a sensing system (e.g., camera) and a label data obtained from a DNN. A sensor (e.g. camera, microphone, etc.) may generate sensing data and may provide the sensing data in a complete format (e.g. an image frame, audio recording, etc.) to an already trained DNN (e.g., convolutional neural network). The sensing data may also be provided in an event format to an untrained SNN. The SNN may be trained based on input data in the event format and the output of the already trained DNN. Further, the SNN may perform signal processing (e.g., facial recognition, object detection) which is more energy efficient than signal processing with the DNN.

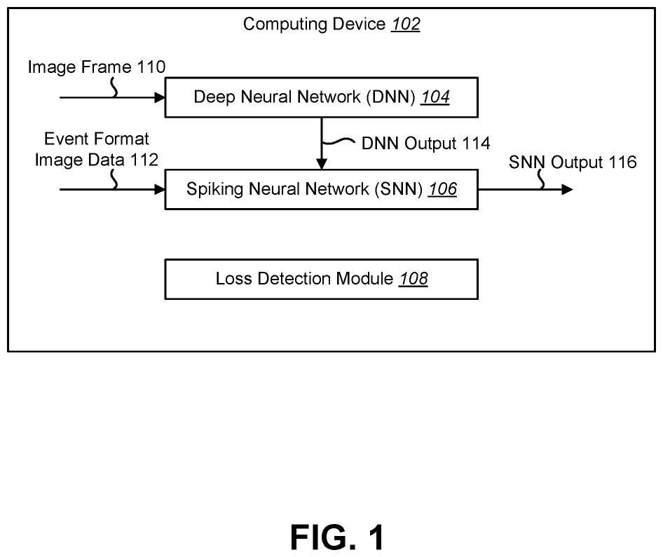

FIG. 1 is an example block diagram of a computing device 102 in which event-based processing using on the output 114 of a deep neural network (DNN) 104 may be performed. The system 100 may include a computing device 102. Examples of computing devices 102 may include desktop computers, laptop computers, tablet devices, smart phones, cellular phones, game consoles, server devices, cameras, and/or smart appliances, etc. In other examples, the computing device 102 may be a distributed set of devices. For example, the computing device 102 may include multiple discrete devices organized in a system to implement the processes described herein. In some implementations, the computing device 102 may include and/or be coupled to a display for presenting information (e.g., images, text, graphical user interfaces (GUIs), etc.).

The computing device 102 may include a processor. The processor may be any of a central processing unit (CPU), a microcontroller unit (MCU), a semiconductor-based microprocessor, GPU, FPGA, an application-specific integrated circuit (ASIC), and/or other hardware devices suitable for retrieval and execution of instructions stored in the memory. The processor may fetch, decode, and execute instructions, stored on the memory and/or data storage, to implement event-based processing using the output 114 of a DNN 104.

The memory may include read only memory (ROM) and/or random access memory (RAM). The memory and the data storage may also be referred to as a machine-readable storage medium. A machine-readable storage medium may be any electronic, magnetic, optical, or other physical storage device that contains or stores executable instructions. Thus, the machine-readable storage medium may be, for example, RAM, EEPROM, a storage device, an optical disc, and the like. In some examples, the machine-readable storage medium may be a non-transitory machine-readable storage medium, where the term “non-transitory” does not encompass transitory propagating signals. The machine-readable storage medium may be encoded with instructions that are executable by the processor.

The computing device 102 may enable functionality for SNN signal processing (e.g., image processing, audio processing) based on the output 114 of a deep neural network DNN. For example, the computing device 102 may include hardware (e.g., circuitry and/or processor(s), etc.) and/or machine-executable instructions (e.g., program(s), code, and/or application(s), etc.) for capturing and processing image data. In some examples, the computing device 102 may include a camera to capture image data. In other examples, the computing device 102 may include a microphone for capturing audio data. In yet other examples, the computing device 102 may include other sensors to capture sensing data other than image data or audio data. It should be noted that an example that includes visual data in the form of an image frame 110 is depicted in FIG. 1. However, other examples may include other types of sensing data (e.g., audio data).

An emerging paradigm in computing is event-driven processing, which is an aspect of research underway within the larger umbrella of brain-inspired computing, also referred to as neuromorphic computing. Event-driven processing bears a similarity to spiking and spike propagation within a human brain. Because the processing is triggered by events, the energy expended by a computing device 102 may be significantly less when compared with non-event-driven systems. For example, in a frame-based camera, an entire image frame 110 is read out periodically, even when changes between image frames 110 are minimal. For example, an entire image frame 110 may be read out and the pixels within the image frame 110 may be processed even when most of the pixels remain unchanged. In comparison, in an event-driven sensor, instead of periodically reading an image frame 110, individual pixels may be read upon detecting a change. In the context of image data, energy efficiency in cameras may be beneficial for continuous sensing at edge conditions and in cases where the cameras may be powered by a battery. For instance, cameras may be installed to monitor crops and may be powered by a battery.

While an event-driven sensor may improve efficiency on the camera capture side, a similar event-driven approach may be implemented for image processing. However, image processing pipelines and computer vision pipelines may be image frame based. For example, deep learning approaches to image processing process image frames 110 as opposed to events. A neuromorphic hardware processor may be based on the spiking paradigm. These processors may include an SNN 106. In some examples, the SNN 106 may be implemented as instructions stored in the memory that are executed by the processor.

The SNN 106 is an artificial neural network that mimics neural networks in a human brain. The SNN 106 may be provided events from an event-driven sensor (e.g., event-driven camera sensor). The events may include a number of spikes as captured by the event-driven sensor. The SNN 106 may perform image processing in a fully event-driven manner, provided the SNN 106 is trained.

Training an SNN 106 presents challenges. In some examples, there may be no training data readily available. Complete-format deep learning has been fortunate with the availability of data in terms of photos, videos, audio and other forms of input. This data availability has been instrumental in driving developments in machine learning. But there is not an available training base when it comes to the spiking paradigm.

In some other examples of challenges faced with training an SNN 106, deep learning systems are trained with well understood visual or auditory representations. However, how a certain image translates to spikes may not be well understood.

The computing device 102 described herein may enable an end-to-end event-driven system for sensing data processing. For example, the event-driven system may be used for image processing (e.g., vision inferencing), audio processing or other sensing applications. Through the use of event-driven processing, the computing device 102 may provide significant improvements in energy efficiency.

Labeled data generation may be used for training the SNN 106 in an end-to-end event-driven camera system used for the sensing data processing. Some examples of image processing that may be performed by the event-driven system described herein include facial recognition, object recognition, scene recognition, activity recognition, facial emotion analysis and/or occurrence of print errors in images.

In some examples, the event-driven processing may also be applied to other sensing data (e.g., from sources such as a microphone or other sensor) that may be classified by a deep learning (DL) system (e.g., voice recognition). For example, event-driven processing may be applied to voice activity detection, person identification with speech, sentiment analysis, sensory processing for emotion detection and/or sensory processing to predict occurrence of events (e.g., predicting failures in a complex system).

In the context of image processing, a camera system may include a camera sensor (e.g., a complementary metal-oxide-semiconductor (CMOS) or charge-coupled device (CCD) sensor) arranged in the form of a two-dimensional (2D) array of pixels. Such a sensor may integrate in pixel wells, as a function of the incident photons. At a predetermined time, the entire pixel array may be read out, which forms an image frame 110 (also referred to as a frame). After the image frame 110 is read, the camera sensor may once again start to integrate for subsequent frames. The image frame read from the camera sensor may be processed by an image processor (also referred to as an image signal processor).

The output (e.g., an RGB image) from the image processor, also in the form of image frames 110, may be provided to a deep neural network (DNN) 104. In some examples, the DNN 104 is a convolutional deep neural network (CNN). In some examples, the DNN 104 may be implemented as instructions stored in the memory that are executed by the processor. The DNN 104 is an artificial neural network that performs deep learning (DL) operations (also referred to as deep structured learning or hierarchical learning). The DNN 104 may be trained to perform image processing on an incoming image frame 110. For example, a classifier at the last stage of the DNN 104 may recognize a subject (e.g., a person) that was captured by the camera sensor.

The computing device 102 may also include an event-driven sensor to capture sensing data. In some examples, the computing device 102 may include an event-driven image sensor. As with the frame-based camera sensor described above, the event-driven image sensor may also include a 2D pixel array and each pixel may integrate as described before. However, the readout of the frame-based camera sensor may not happen on a pre-determined and periodic interval. Instead, the readout of the frame-based camera sensor may be triggered when a certain pixel well reaches a threshold indicating significant change, which is referred to herein as an event. In other examples, the event-driven sensor may capture other non-visual sensing data (e.g., event format audio data).

When events are generated, the events may be exported from the frame-based sensor as event format data. For example, when events associated with visual data are generated, the events may be exported from the frame-based camera sensor as event format image data 112. The events thus captured may be encoded. For example, the events may be encoded by a scheme called address event representation (AER) and exported via an AER bus. The events included in the event format image data 112 may be sent to an event processor. The event processor may synchronize the event format image data 112 with a given image frame 110. In some examples, the event processor may perform signal processing operations for the incoming spike train. For instance, the event processor may implement a high-pass filter to sample when there is dominant spike activity.

Substantial gains in energy efficiency may be achieved with this event-driven approach. However, as described above, training an end-to-end event processing system may be challenging. For example, manually generating and labeling training data for the SNN 106 is not very practical.

The event-driven processing described herein may leverage the large installed base of training data sets for the DNN 104. For example, the DNN 104 may be trained for image processing an image frame 110. In some examples, a real-time camera equipped with a DNN 104 trained for facial recognition may recognize a person. In other examples, a computing device 102 equipped with a DNN 104 trained for voice recognition may recognize a person based on an audio signal captured by a microphone.

This system may provide both sensing data (e.g., an image frame 110 captured by the camera) and additional metadata associated with the sensing data (e.g., the name of the person recognized by the DNN 104 facial recognition system). The sensing data (e.g., image frame 110) may serve as data for the SNN training. The metadata may serve as labels for the data. The DNN output 114 (e.g., the label and/or timestamp) that has been generated may be provided to the SNN 106 to train the SNN 106 for processing of the event format data.

The output 114 of the DNN 104 may include labeled sensing data corresponding in time to the event format data. In the context of visual data, the DNN output 114 may include labeled data of the image frame 110 corresponding in time to the event format image data 112. For example, the image frame 110 (and associated labeled data) may be synchronized in time with the event format image data 112.

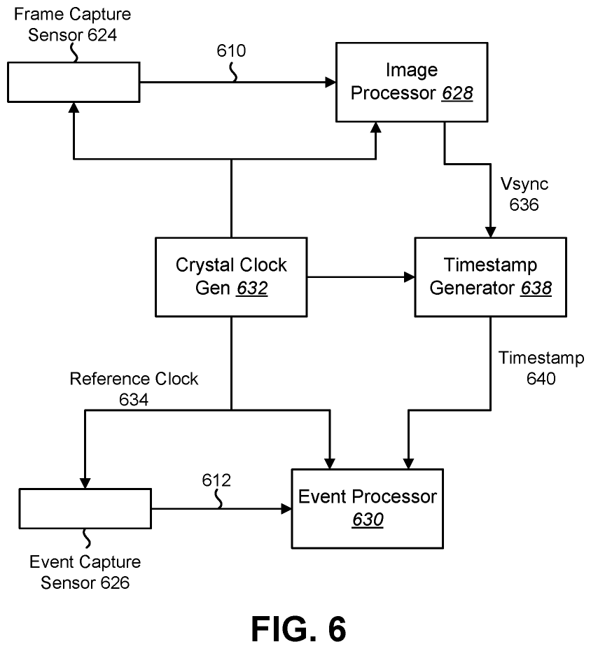

In some examples, the event format data may be synchronized with the sensing data based on a common clock signal and a timestamp of the sensing data. In the context of visual data, event format image data 112 may be synchronized with the image frame 110 based on a common clock signal and a timestamp of the image frame 110. An example of the time synchronization is described in connection with FIG. 6.

The SNN 106 may perform processing of the event format data based on the output 114 of the DNN 104. In the context of visual data, the SNN 106 may perform image processing of the event format image data 112 based on the output 114 of the DNN 104. For example, the SNN 106 may perform facial recognition, object recognition, etc. on the event format image data 112 using the DNN output 114. As described above, the DNN output 114 may include labeled data, which the SNN 106 may use to train its image processing. In some examples, training the SNN 106 may include spike timing dependent plasticity (STDP) training or others training methods. The results of the SNN image processing are the SNN output 116.

The SNN 106 may identify a significant event in the event format data (e.g., event format image data 112) based on the DNN output 114. In an example, the DNN 104 may perform facial recognition on a subject observed by the camera. In this case, the DNN output 114 may include labeled data associated with the facial recognition. Some examples of the labeled data (e.g., the metadata) included in the DNN output 114 may include the following: the number of faces being tracked; the face number (e.g., identification (ID)) of each face being tracked; the x, y coordinates of each bounding box of a tracked face; the dimensions (e.g., depth (d) and width (w)) of each bounding box; and/or an arrival timestamp of when each face is first seen.

Once the SNN 106 is fully trained for processing of the event format data, the SNN 106 may process the event format data without using the DNN output 114. For example, when the SNN 106 is fully trained for image processing of the event format image data 112, the SNN 106 may perform the image processing without using the DNN output 114. In this case, the DNN 104 may be disabled. In some examples, the computing device 102 may include a loss detection module 108 that determines the loss between the output 114 of the DNN 104 and an output 116 of the SNN 106. In some examples, the loss detection module 108 may be implemented as instructions stored in the memory that are executed by the processor.

In order to determine when the SNN 106 is trained, the loss detection module 108 (also referred to as a loss function) may measure how well the DNN output 114 matches the SNN output 116. When the SNN 106 is being trained by the DNN output 114, over time the loss reduces. The training may be deemed complete when the loss reaches a threshold (e.g., a user defined threshold). Once the training is complete, the DNN 104 may be deactivated, which will improve the energy efficiency of the computing device 102. In other words, the DNN 104 may be disabled when the loss is within the threshold.

In some examples, it may be impractical (e.g., take too long) for an untrained SNN 106 to be deployed in the field to be trained. Instead, the SNN 106 may be attached to a playback system (e.g., photo/video playback system, audio playback system, etc.) with a large training database that the DNN 104 has been trained on. Using this system, the SNN 106 may be trained before being deployed. In this case, the event-driven system may be rebuilt into a separate housing without the DNN 104, which may reduce the cost of the computing device 102.

In some examples, additional online training may be avoided once the SNN 106 is fully trained. However, in some cases, fine-tuning may be performed based on the real-world data obtained in the field. In this case, some online learning may be performed. Alternatively, the computing device 102 may be taken offline briefly to train with the most recent data. In each of these cases, the DNN 104 may be retained and activated/deactivated for training purposes. The loss detection module 108 may be reprogrammed to target a threshold value as desired. Eventually, the low-power event-driven system may be used for image processing independent of the DNN 104, and the DNN 104 may be deactivated. Therefore, the training system may be viewed as an energy efficient system, but with supplemental assistance provided by the DNN 104. The supplemental assistance may be deactivated when the SNN 106 is fully trained.

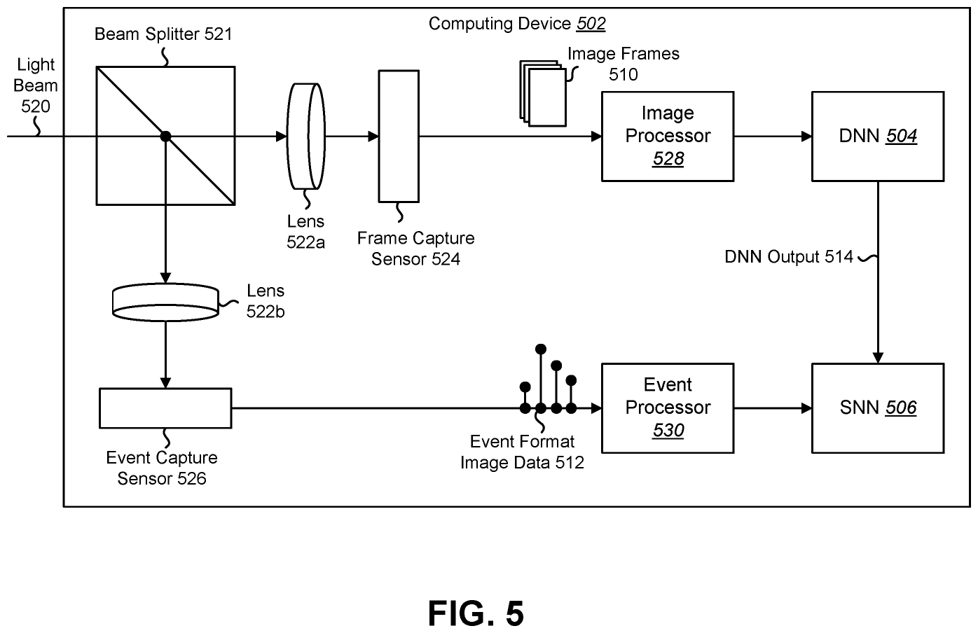

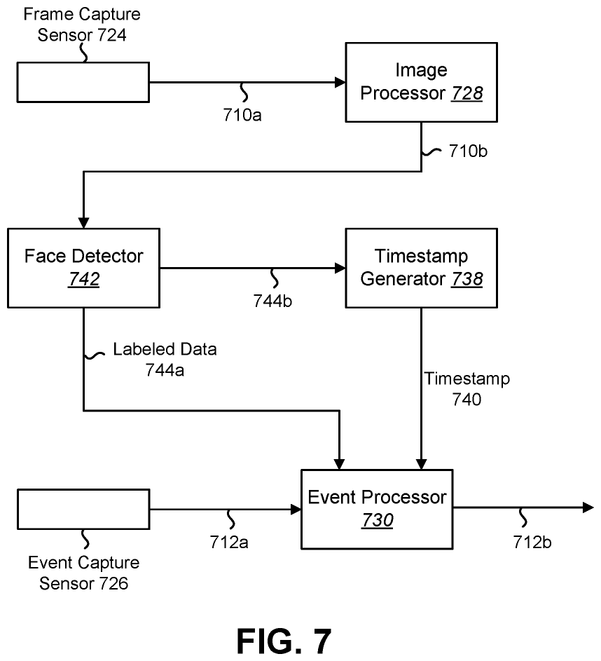

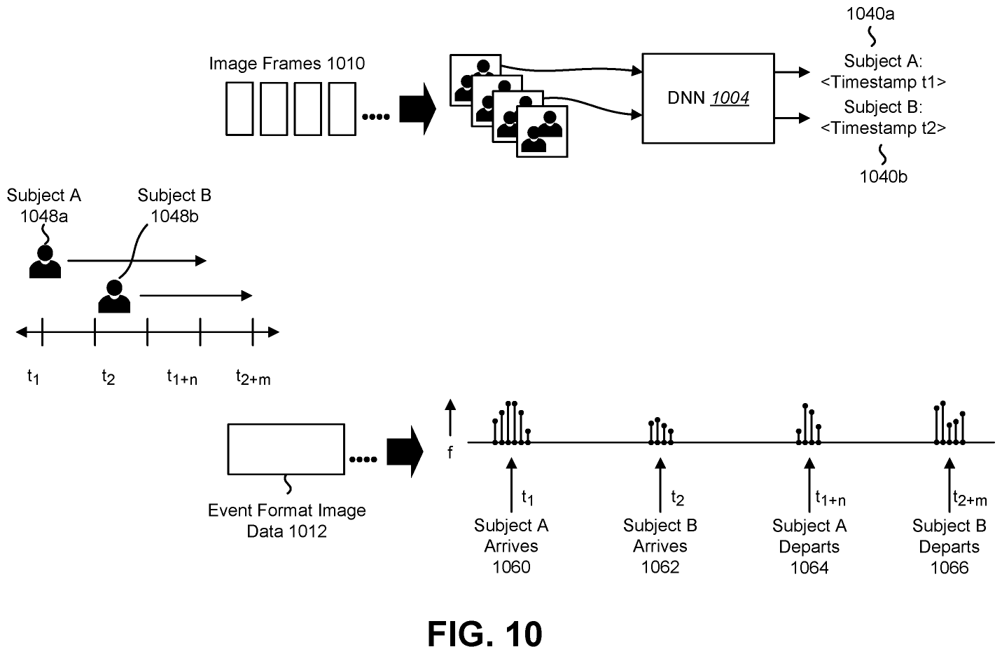

Some additional aspects of using the DNN output 114 for training the SNN 106 are described herein. Field of view (FOV) correspondence between the frame-based camera system and the event-driven camera system is described in connection with FIG. 5. Time synchronization between the frame-based camera system and the event-driven camera system is described in connection with FIG. 6. Spatial-temporal correspondence between the frame-based camera system and the event-driven camera system is described in connection with FIG. 7. Labeled data generation is described in connection with FIG. 10.

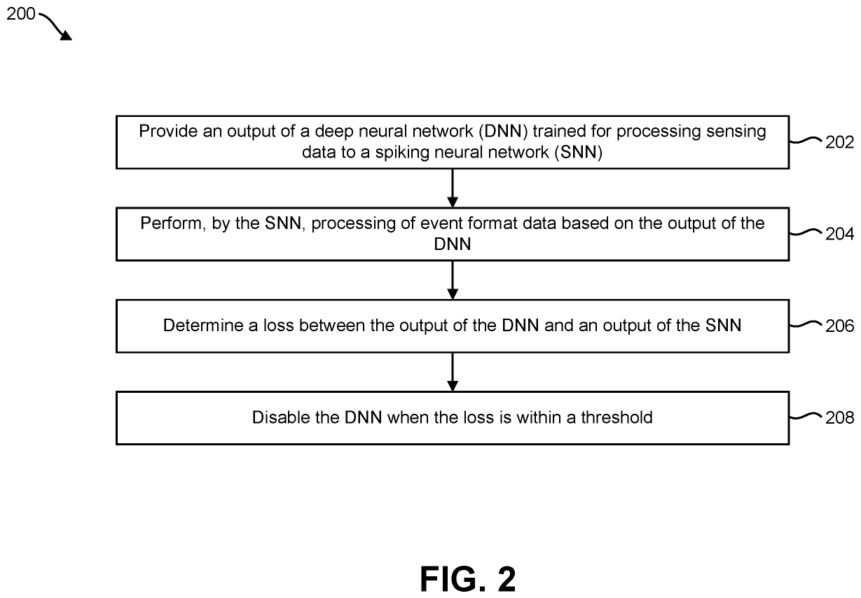

FIG. 2 is an example flow diagram illustrating a method 200 for event-based processing using the output 114 of a DNN 104. The computing device 102 may provide 202 an output 114 of a DNN 104 trained for processing sensing data (e.g., visual data, audio data, etc.) to an SNN 106. For example, the DNN 104 may be a convolutional neural network that is trained to perform image processing (e.g., identifying faces, objects, scenes and/or activities in an image frame 110), audio processing (voice recognition in an audio signal) and/or other types of signal processing (e.g., voice activity detection, person identification with speech, sentiment analysis, sensory processing for emotion detection, and/or sensory processing to predict occurrence of events (e.g., predicting failures in a complex system)).

The DNN output 114 may include labeled sensing data corresponding in time to event format data received by the SNN 106. The labeled data may include metadata determined by the DNN 104 upon processing the sensing data. In some examples, the event format data may be synchronized with the sensing data based on a common clock signal and a timestamp of the sensing data.

The SNN 106 may perform 204 processing of the event format data based on the output 114 of the DNN 104. The event format data may include a number of encoded events that are captured by an event sensor. The SNN 106 may receive the event format data based on a threshold indicating a significant change in the event format data.

The SNN 106 may identify a significant event in the event format data based on the DNN output 114. For example, the metadata included in the DNN output 114 may identify a certain image processing occurrence (e.g., facial recognition, object recognition) or an audio processing occurrence (e.g., voice recognition). The SNN 106 may use the DNN output 114 to distinguish significant events from insignificant events in the event format data. In this manner, the SNN 106 may be trained to perform signal processing of the event format data.

The computing device 102 may determine 206 a loss between the output 114 of the DNN 104 and the output 116 of the SNN 106. For example, the computing device 102 may measure how well the DNN output 114 matches the SNN output 116. When the SNN 106 is being trained by the DNN output 114, over time the loss may reduce.

The computing device 102 may disable 208 the DNN 104 when the loss is within a threshold. For example, training of the SNN 106 may be deemed complete when the loss reaches a threshold (e.g., a user defined threshold or predefined threshold). Once the SNN training is complete, the DNN 104 may be disabled (e.g., deactivated), which will improve the energy efficiency of the computing device 102.

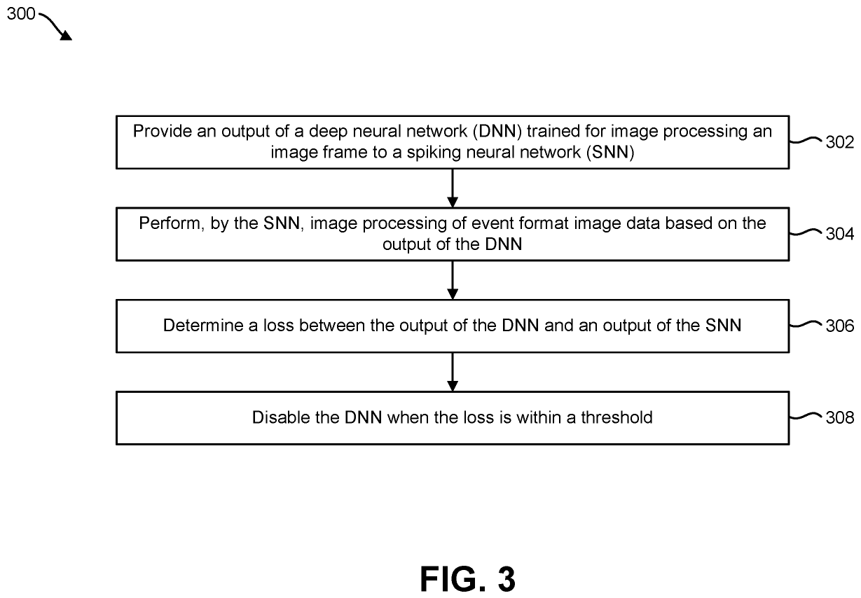

FIG. 3 is an example flow diagram illustrating another method 300 for event-based processing using the output 114 of a DNN 104. The computing device 102 may provide 302 an output 114 of a DNN 104 trained for image processing an image frame 110 to an SNN 106. For example, the DNN 104 may be a convolutional neural network that is trained to identify faces, objects, scenes and/or activities in an image frame 110.

The DNN output 114 may include labeled data of the image frame 110 corresponding in time to event format image data 112 received by the SNN 106. The labeled data may include metadata determined by the DNN 104 upon image processing the image frame 110. In some examples, the event format image data 112 may be synchronized with the image frame 110 based on a common clock signal and a timestamp of the image frame 110.

The SNN 106 may perform 304 image processing of the event format image data 112 based on the output 114 of the DNN 104. The event format image data 112 may include a number of encoded events that are captured by an event sensor. The SNN 106 may receive the event format image data 112 based on a threshold indicating a significant change in the event format image data 112. Therefore, the SNN 106 may receive the event format image data 112 on the basis of detected changes in a scene. This differs from a frame-based camera system, which provides image frames 110 on a periodic basis.

The SNN 106 may identify a significant event in the event format image data 112 based on the DNN output 114. For example, the metadata included in the DNN output 114 may identify a certain image processing occurrence (e.g., facial recognition, object recognition). The SNN 106 may use the DNN output 114 to distinguish significant events from insignificant events in the event format image data 112. In this manner, the SNN 106 may be trained to perform image processing of the event format image data 112.

The computing device 102 may determine 306 a loss between the output 114 of the DNN 104 and the output 116 of the SNN 106. For example, the computing device 102 may measure how well the DNN output 114 matches the SNN output 116. When the SNN 106 is being trained by the DNN output 114, over time the loss may reduce.

The computing device 102 may disable 308 the DNN 104 when the loss is within a threshold. This may be accomplished as described in connection with FIG. 2.

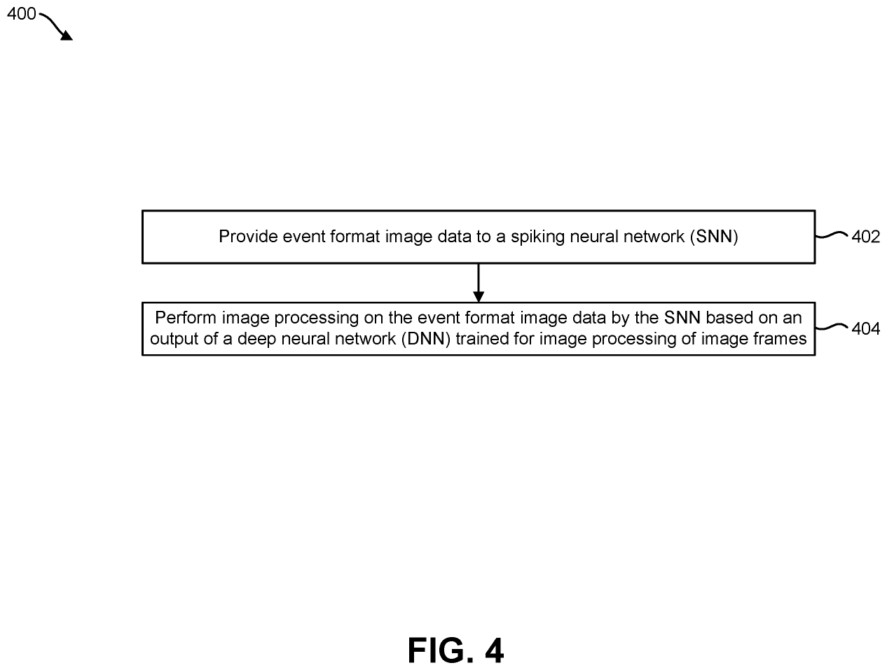

FIG. 4 is an example flow diagram illustrating another method 400 for event-based processing using the output 114 of a DNN 104. The computing device 102 may provide 402 event format image data 112 to a spiking neural network (SNN) 106. The event format image data 112 may include a number of encoded events that are captured by an event sensor. The SNN 106 may receive the event format image data 112 based on a threshold indicating a significant change in the event format image data 112.

The SNN 106 may perform 404 image processing on the event format image data 112 based on the output 114 of a DNN 104 trained for image processing of image frames 110. In some examples, the SNN 106 may have been previously trained by the DNN 104. In some implementations, the computing device 102 may include an SNN 106 that is trained by the DNN 104 but the computing device 102 may not actually include the DNN 104. In other implementations, the computing device 102 may include both an SNN 106 and a DNN 104.

The DNN 104 may be a convolutional neural network (CNN) that is trained to identify faces, objects, scenes and/or activities in an image frame 110. The DNN output 114 may include labeled data of the image frame 110 corresponding in time to the event format image data 112 received by the SNN 106. The labeled data may include metadata determined by the DNN 104 upon image processing the image frame 110. The DNN output 114 may be provided to the SNN 106.

The SNN 106 may identify a significant event in the event format image data 112 based on the DNN output 114. For example, the metadata included in the DNN output 114 may identify a certain image processing occurrence (e.g., facial recognition, object recognition). The SNN 106 may use the DNN output 114 to distinguish significant events from insignificant events in the event format image data 112. In this manner, the SNN 106 may be trained to perform image processing of the event format image data 112. In some examples, training the SNN 106 may include spike timing dependent plasticity (STDP) training or others training methods using the DNN output 114.

The computing device 102 may disable the DNN 104 when the SNN 106 is fully trained by the DNN 104. For example, the computing device 102 may determine that the SNN 106 is fully trained by the DNN 104 based on a loss between the DNN output 114 and the SNN output 116. For example, training of the SNN 106 may be deemed complete when the loss reaches a threshold (e.g., a user defined threshold or predefined threshold). Once the SNN training is complete, the DNN 104 may be disabled (e.g., deactivated).

FIG. 5 is another example block diagram of a computing device 502 in which event-based processing using the output 514 of a DNN 504 may be performed. The computing device 502 may be an example of the computing device 102 described in connection with FIG. 1 in some implementations.

Field of view (FOV) correspondence may be performed between the frame-based camera system and the event-driven camera system. For instance, each of the frame-based camera system and event-driven camera system may be provided the same data. There should no difference due to parallax or other reasons.

In some examples, to accomplish FOV correspondence, a beam splitter 521 may be used to split a light beam 520 captured by the camera of the computing device 502. Upon passing through the beam splitter 521, one light beam 520 may pass through a lens 522a to a frame capture sensor 524 (e.g., CMOS sensor) for the frame-based camera system. The frame capture sensor 524 may capture image frames 510, which are provided to the image processor 528. The image processor 528 may output RGB image frames 510 to the DNN 504.

The beam splitter 521 may direct another light beam 520 through the lens 522b of an event capture sensor 526 (e.g., CMOS sensor) for the event-based camera system. Event format image data 512 may include a number of encoded events that are captured by the event sensor 526. The event format image data 512 may be provided to the event processor 530. The event processor 530 may output the event format image data 512 to the SNN 506.

The SNN 506 may receive the output 514 of the DNN 504. The SNN 506 may perform image processing using the DNN output 514 as described in connection with FIG. 1.

FIG. 6 is an example block diagram illustrating time synchronization for the event-based processing described herein. The frame-based system and the event-driven systems described herein may be synchronized. In some examples, a global reference clock 634 may be generated from a common crystal clock generator 632. The global reference clock 634 may be communicated to the frame capture sensor 624, the image processor 628, the event capture sensor 626, the event processor 630 and a timestamp generator 638.

The timestamp generator 638 may create a periodic time reference which is derived from the arrival rate of a periodic vertical sync signal (Vsync) 636 (also referred to as a vertical blank) in the frame-based system. For example, the frame capture sensor 624 may output a Vsync 636 at the start of every new image frame 610. The timestamp generator 638 may use the Vsync 636 to generate a timestamp 640 for a given image frame 610.

The timestamp 640 may be used by the event processor 630 to synchronize the frame-based system. For example, the event processor 630 may synchronize the event format image data 612 captured by the event capture sensor 626 with an image frame 610 using the reference clock 634 and the timestamp 640 of the image frame 610. Periodic re-synchronization may minimize drift of the event format image data 612 and the image frame 610.

FIG. 7 is an example block diagram illustrating spatial-temporal correspondence for the event-based processing described herein. In an example of facial recognition, an event-driven camera may detect a high frequency of events when a face appears. But there may be similar high density of events due to change in surroundings or other persons. Therefore, the events corresponding to the face that is being recognized may be localized.

In some examples, the event localization may be accomplished by establishing where (e.g., spatial information) the person is situated within an image frame 710 to when (e.g., temporal information) the person appeared within those coordinates. The example for spatial to temporal correspondence shown in FIG. 7 may use a face detector 742 and a timestamp generator 738 (as described in connection with FIG. 6).

A frame capture sensor 724 may capture an image frame 710a. The face detector 742 may receive the image frame 710b from an image processor 728. The face detector 742 may detect a face in the image frame 710b. The face detector 742 may also detect spatial coordinates associated with the face within the image frame 710b. The face detector 742 may provide labeled data 744a associated with the image frame 710b to the event processor 730. In some examples, the face detector 742 may provide the number of faces being tracked; the face number (e.g., identification (ID)) of each face being tracked; the x, y coordinates in the image frame 710 of each bounding box of a tracked face; and/or the dimensions (e.g., depth (d) and width (w)) of each bounding box.

The timestamp generator 738 may generate a timestamp 740 for when the face was first detected at the spatial coordinates. For example, the timestamp generator 738 may receive labeled data 744b from the face detector 742. The timestamp generator 738 may generate a timestamp 740 for when the face was first detected at a given set of spatial coordinates using the labeled data 744b. The timestamp generator 738 may provide the timestamp 740 to the event processor 730.

The event processor 730 may receive event format image data 712a from an event capture sensor 726. The event processor 730 may synchronize the event format image data 712a with a given image frame 710a using the labeled data 744a and the timestamp 740 of the given image frame 710a.

The event processor 730 may bind temporal values and spatial values, and generate metadata. In some examples, the metadata may include timestamps 740, the number of faces, bounding box size and coordinates. The event processor 730 may encapsulate the metadata along with the schedule of events. The event processor 730 may output event format image data 712b that includes events and corresponding labeled data (e.g., metadata).

In some examples, this approach also works for multiple faces. At any given time, the face detector 742 may track several faces by means of a counter. For each face, the face detector 742 may provide the coordinates of the center of the bounding box, as well as the length and width of the bounding box. The information from the face detector 742 is provided to the event driven system.

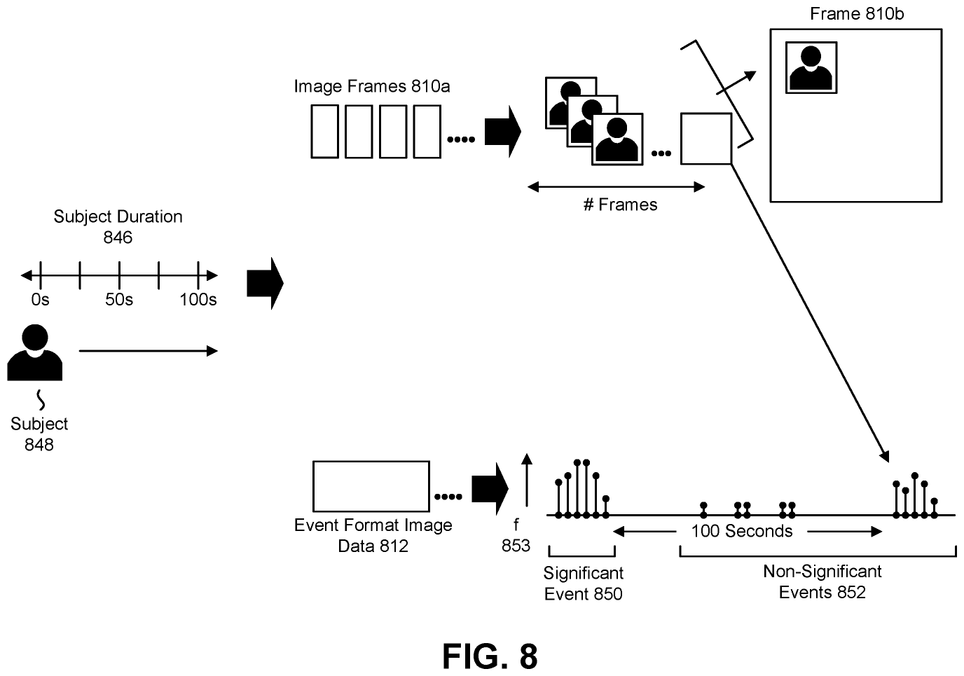

FIG. 8 is an example illustrating an implementation of spatial-temporal correspondence for event-based processing. In this example, a subject 848 (e.g., a person or object) appears in the FOV of a camera (or within the present coordinates of an image frame 810) for a duration of time (subject duration 846). In this case, the subject 848 is observed for 100 seconds.

An image frame sensor may capture a number of image frames 810 at a certain rate. The event sensor may capture event format image data 812. In this case, the event format image data 812 is accompanied by a high frequency 853 of events in the event-based system. When the subject 848 is initially recognized within a set of spatial coordinates of the image frame 810b, this is significant window of events (referred to as a significant event 850 or salient event). The spiking neural network (SNN) 106 may be trained to identify the significant event 850.

On the other hand, when the subject 848 leaves the spatial coordinates or leaves altogether from the FOV of the camera, this will also result in a high frequency 853 of events. However, these events may be considered non-significant events 852 (also referred to as non-salient events). In other words, the non-significant events 852 may include a window of events that are not meaningful for the SNN 106 to train on. By this spatial-temporal mechanism, it is possible to filter the non-significant events 852.

In some examples, the SNN 106 may train on the labels for significant events 850, which are salient to learn. The SNN 106 may ignore the non-significant events 852.

As the event significance is based on spatial coordinates within an image frame 810, the spatial-temporal correspondence approach described herein may also address the case where the subject 848 moves to different coordinates on future image frames 810. This movement may result in a new set of significant events 850. Hence a subject 848 that is recognized may be tracked.

In some cases, spurious events are likely to be triggered due to background changes, lighting changes and noise. By clearly indicating the coordinates on the frame and the corresponding time window for significant events 850, the SNN 106 can be trained to de-emphasize spurious events. Jitter, also due to noise, and vibrations, may also be a source of spurious events. These spurious events could be optionally eliminated by a high pass filter. Or, as before, the SNN 106 can learn to ignore these spurious events through training. The latter approach could help prevent over-fitting.

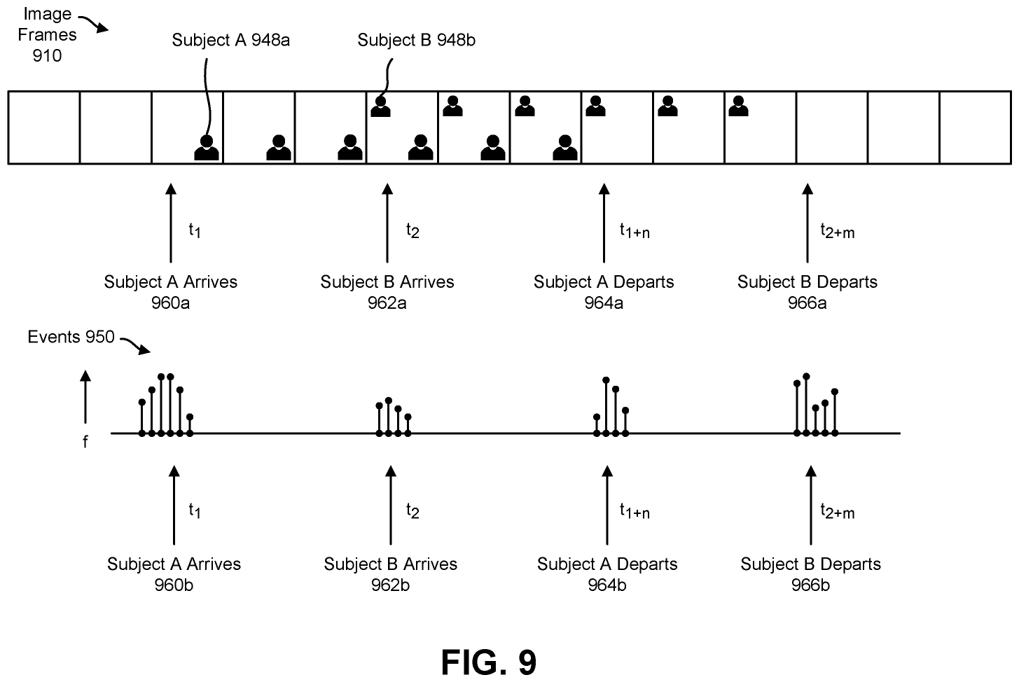

FIG. 9 is an example illustrating another implementation of spatial-temporal correspondence for event-based processing. In some examples, the spatial-temporal correspondence approaches described herein may be used to disambiguate (e.g., differentiate) between subjects 948 when more than one subject 948 is present.

In this example, a number of image frames 910 are depicted with corresponding events 950. The events 950 may be characterized by a frequency of spikes.

A first subject 948a (e.g., a person) enters an image frame 910 at time t₁ 960a. A corresponding event 950 may be captured at time t₁ 960b.

A second subject 948b (e.g., a second person) enters an image frame 910 at time t₂ 962a. A corresponding event 950 may be captured at time t₂ 962b.

The first subject 948a may depart an image frame 910 at time t₁₊ₙ 964a. A corresponding event 950 may be captured at time t₁₊ₙ 964b.

The second subject 948b may depart an image frame 910 at time t₂₊ₘ 966a. A corresponding event 950 may be captured at time t₂₊ₘ 966b.

The SNN 106 may be trained to differentiate between the two subjects 948a-b. For example, the SNN 106 may be trained using the events 950 when the first subject 948a arrives at time t₁ 960b to identify the first subject 948a. The SNN 106 may also be trained using the events 950 when the second subject 948b arrives at time t₂ 962b to identify the second subject 948b. Because the events 950 for each subject 948 differ, the SNN 106 may be trained to differentiate between the two subjects 948a-b.

FIG. 10 is an example of labeled data generation for event-based processing. In this example, a first subject 1048a (Subject A) and a second subject 1048b (Subject B) may be observed by a camera, as described in connection with FIG. 9.

In some examples, the image frames 1010 from the frame-based system may be provided to the DNN 1004 for facial recognition. The DNN 1004 may be located within a camera training system of a computing device 102 for further training of the SNN 106, or could be located elsewhere (e.g., the cloud) as the DNN 1004 may not be used for further real-time applications.

In some examples, the facial recognition system of the DNN 1004 may output metadata associated with each subject 1048a-b. For example, the DNN 1004 may output a subject identifier (e.g., name) of the subject within the bounding box. In the example below, the first subject 1048a is recognized as Subject A, and the second subject 1048b who joins later is identified as Subject B.

The frame-based system may also propagate the timestamp 1040 that is generated to the event-based system. For example, the DNN 1004 may generate a first timestamp 1040a for t₁ corresponding to the arrival of the first subject 1048a. The DNN 1004 may also generate a second timestamp 1040b for t₂ corresponding to the arrival of the second subject 1048b. Thus, the output of the subject identifier (e.g., name) may be accompanied by the timestamp 1040 of when the subject 1048 was first seen.

With this information and the metadata encapsulated within the event sequence, the labeled image data for a given subject 1048 may be reconciled between the frame-based system and the event-based system. For example, the event processor may use the timestamps 1040 to combine the data (e.g., a given event in the event format image data 1012) with a corresponding label (e.g., the subject identifier).

In some examples, significant events may be associated with a label or timestamp. Non-significant events may not have a label or timestamp. For example, the event at time t₁ 1060 corresponding with the arrival of the first subject 1048a may have an associated timestamp 1040a and label (e.g., subject identifier of Subject A). Similarly, the event at time t₂ 1062 corresponding with the arrival of the second subject 1048b may have an associated timestamp 1040b and label (e.g., subject identifier of Subject B). However, the DNN 1004 may not generate a timestamp and label for the non-significant events of the departure of the first subject 1048a at time t₁₊ₙ 1064 and the departure of the second subject 1048b at time t₂₊ₘ 1066.

Because the non-significant events do not have labels and/or timestamps, the SNN 106 may not be trained to recognize these non-significant events. In other words, the SNN 106 may be trained to ignore the non-significant events by withholding labels and/or timestamps for the non-significant events.

1. A method, comprising:
providing an output of a deep neural network (DNN) trained for processing sensing data to a spiking neural network (SNN);
performing, by the SNN, processing of event format data based on the output of the DNN; and
determining a loss between the output of the DNN and an output of the SNN, wherein the DNN is disabled when the loss is within a threshold.

2. The method of claim 1, wherein the output of the DNN comprises labeled sensing data corresponding in time to the event format data.

3. The method of claim 1, further comprising synchronizing the event format data with the sensing data based on a common clock signal and a timestamp of the sensing data.

4. The method of claim 1, further comprising identifying, by the SNN, a significant event in the event format data based on the output of the DNN.

5. The method of claim 1, further comprising distinguishing, by the SNN, between a significant event and an insignificant event in the event format data based on the output of the DNN.

6. A computing device, comprising:
a deep neural network (DNN) trained for image processing an image frame;
a spiking neural network (SNN) to perform image processing of event format image data based on an output of the DNN; and
a loss detection module to determine a loss between the output of the DNN and an output of the SNN, wherein the DNN is disabled when the loss is within a threshold.

7. The computing device of claim 6, further comprising an event processor that synchronizes the event format image data with the image frame.

8. The computing device of claim 7, wherein the event processor synchronizes the event format image data with the image frame based on a common clock signal and a timestamp of the image frame.

9. The computing device of claim 6, wherein the SNN identifies a significant event in the event format image data based on metadata included in the output of the DNN.

10. The computing device of claim 6, wherein an event capture sensor provides the event format data to the SNN based on a threshold indicating a significant change in the event format data.

11. A non-transitory machine-readable storage medium encoded with instructions executable by a processor, the machine-readable storage medium comprising:
instructions to provide event format image data to a spiking neural network (SNN); and
instructions to perform image processing on the event format image data by the SNN, wherein the SNN is trained for image processing the event format image data based on an output of a deep neural network (DNN) trained for image processing of image frames.

12. The machine-readable storage medium of claim 11, further comprising instructions to determine that the SNN is fully trained by the DNN based on a loss between the output of the DNN and an output of the SNN.

13. The machine-readable storage medium of claim 11, further comprising instructions to disable the DNN when the SNN is fully trained by the DNN.

14. The machine-readable storage medium of claim 11, wherein the SNN processes the event format image data without using the output of the DNN.

15. The machine-readable storage medium of claim 11, wherein the SNN is pretrained for image processing the event format image data based on the output of the DNN, and wherein the SNN is included in a computing device without the DNN.
